(19) United States
(12) Patent Application Publication
(10) Pub. No.: US 2026/0302746 A1
(43) Pub. Date: Oct. 1, 2026

(54) Electrical Box Opening Template

(71) Applicant: Seamless Tools LLC, Millcreek, UT (US)

(72) Inventor: Richard Green, Millcreek, UT (US)

(21) Appl. No.: 19/631,852

(22) Filed: Mar. 27, 2026

Related U.S. Application Data
(60) Provisional application No. 63/781,126, filed on Mar. 31, 2025.

(51) Int. Cl. H02G 3/12; H02G 3/08

(52) U.S. Cl. CPC H02G 3/121; H02G 3/081

(57) ABSTRACT

A template for preparing an opening for electrical utility boxes is disclosed. The template comprises an inner plate with an aperture. The aperture is configured to define an outline of the opening to accommodate an electrical utility box. A frame surrounds a portion of the inner plate. A guide directs a cutting tool. The guide is positioned between the inner plate and the frame. The template is configured to adhere to a wall and to remain adhered to the wall as the guide directs the cutting tool in preparing the openings in the drywall. The opening is configured to accommodate an electrical utility box. A frame of a second thickness, greater than the first thickness, surrounds a portion of the inner plate. The template adheres to a wall and remains in place as the opening is cut in the drywall.

### TECHNICAL FIELD

This disclosure relates to tools used in preparing interior walls for electrical utility boxes, such as boxes for electrical outlets and light switches; as well as electrical boxes.

### BACKGROUND

Electrical outlets and light switches are important elements in homes and businesses. In order to provide a quality appearance for the finished construction it is important to ensure that the electrical outlets, and light switches are properly positioned on the walls. The position of these outlets and switch plates is typically determined by the position of the electrical utility box which is covered by the outlet plate or light switch plate. It is important, therefore, to ensure that the electrical box covered by the plate is properly positioned. Proper positioning of the electrical box includes vertical and horizontal alignment.

The installation of electrical utility boxes requires an accommodating hole so that wires can be drawn therethrough and that the electrical utility box be properly mounted. Generally, in the case of old work or renovation, a wall is prepared for installation by impressing the face of the electrical utility box against the surface of the wall and outlining its contours with a marking implement so that an opening can be cut to the desired specification. This procedure is rarely reliable because outlet boxes are cumbersome to hold. Additionally, unless extraordinary care is taken, the outline is not always level with the ceiling lines or baseboard or is not aligned with the wall lines. In the case of new construction, an electrical box is secured to the wall or ceiling framework prior to drywall installation by various means.

### SUMMARY

In a first aspect, this disclosure provides a template for preparing an opening for electrical utility boxes. The template comprises an inner plate with an aperture. The aperture is configured to define an outline of the opening to accommodate an electrical utility box. A frame, which surrounds a portion of the inner plate. A guide for directing a cutting tool. The guide is positioned between the inner plate and the frame. The template is configured to adhere to a wall and to remain adhered to the wall as the guide directs the cutting tool in preparing the openings in the drywall.

In some implementations the frame which surrounds at least a portion of the inner plate, surrounds the entire inner plate.

In some implementations, the inner plate comprises a first thickness and the frame comprises a second thickness. The second thickness of the frame may be greater than the first thickness of the inner plate. In implementations where the second thickness of the frame is greater than the first thickness of the inner plate, the greater thickness of the frame at the interface between the inner plate and the frame creates a ridge or a lip. This ridge or lip acts as a guide for cutting tools with a base. Such cutting tools include routers. The guide is therefore configured to direct a router in preparing the openings in the drywall.

The template is designed to adhere to a wall so that it remains in place as an opening is cut into the drywall. Piercing barbs are used to adhere the template to the wall. The piercing barbs are positioned on the template so that when a cover is installed over the openings in the drywall, any indentations created by the barbs are covered by the cover.

Alignment aids assist in properly aligning the template on a wall. Some alignment aids are positioned around a periphery of the frame. Increment marks in the template act as a measuring device to assist in properly aligning the opening before and during cutting of the opening. Mounting holes may be used for attaching the template to a board to position the opening a set distance above a surface. Attaching the template to a board allows for easily repeated preparation of multiple openings by placing the template with the board in position. This eliminates measuring and errors that could occur in measurement. A cinch divot in the attachment holes allows for attaching and securing a line without the necessity of tying knots or using a toggle that prevents the line from slipping through the hole. With the cinch divot a line is easily movable to another position. If a line is used as a plumb line, with a plumb bob attached, the plumb bob may be moved by lifting the line out of the cinch divot moving the line to the desired position and replacing it within the cinch divot. The template may be constructed of a transparent material. The template may include a level.

In a second aspect, this disclosure provides a template for cutting openings in drywall. The template comprises an inner plate of a first thickness, comprising an aperture configured to accommodate an electrical utility box. A frame of a second thickness, greater than the first thickness, surrounds a portion of the inner plate. The template adheres to a wall and remains in place as the opening is cut in the drywall.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative, and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a front view of a template for preparing an opening in drywall.

FIG. 2 is a back view of a template for preparing an opening in drywall.

FIG. 3 is a front view of a template for preparing an opening in drywall with a plumb bob attached to a cinch divot.

FIG. 4 is a front view of a template for preparing an opening in drywall.

FIG. 5 is a front perspective view of a self-securing single gang electrical box.

FIG. 6 is a top-down perspective view of a self-securing single gang electrical box.

FIG. 7 is a back view of a self-securing single gang electrical box.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “electrical utility box” means an enclosure for housing electrical outlets, electrical switches, or electrical junctions. Electrical utility boxes are configured to hold from one to four electrical devices. In some instances, electrical utility boxes may hold more than four electrical devices. The number of devices held by a box is referred to as a gang, for example, a one gang box will hold a single electrical switch or electrical outlet, a two gang box will hold two electrical switches, two electrical outlets, or an electrical switch and an electrical outlet. A three gang box will hold three devices and a four gang box will hold four devices. In some instances, an electrical utility box may hold more than four devices.

As used herein, “drywall” means a building material used to create interior walls and ceilings. Drywall materials include plywood, wood pulp, asbestos-cement board, and gypsum. One of the most common drywall types is the gypsum panel. Gypsum, a natural mineral in crystalline form, is a hydrous sulfate of calcium. Gypsum board contains a gypsum rock core sandwiched between two layers of special paper. In fire-resistant panels, required for many types of construction, glass fibers are mixed with the gypsum base. Panels manufactured with aluminum backing are used for insulation. Gypsum drywall is manufactured both unfinished and finished with a variety of vinyl and other finishes in permanent colors and textures that require no additional treatment to complete the appearance of interior wall surfaces.

Electrical devices such as outlets and electrical switches are housed in boxes, called electrical utility boxes. The electrical utility boxes protect the components of the devices and provide a way for the electrical devices to be secured in place. Often the electrical utility boxes are secured to studs. Additionally, the electrical utility boxes enable the electrical devices to remain out of view behind the drywall. The openings through which the electrical utility boxes are installed need to be cut after the drywall is installed in the interior of the building.

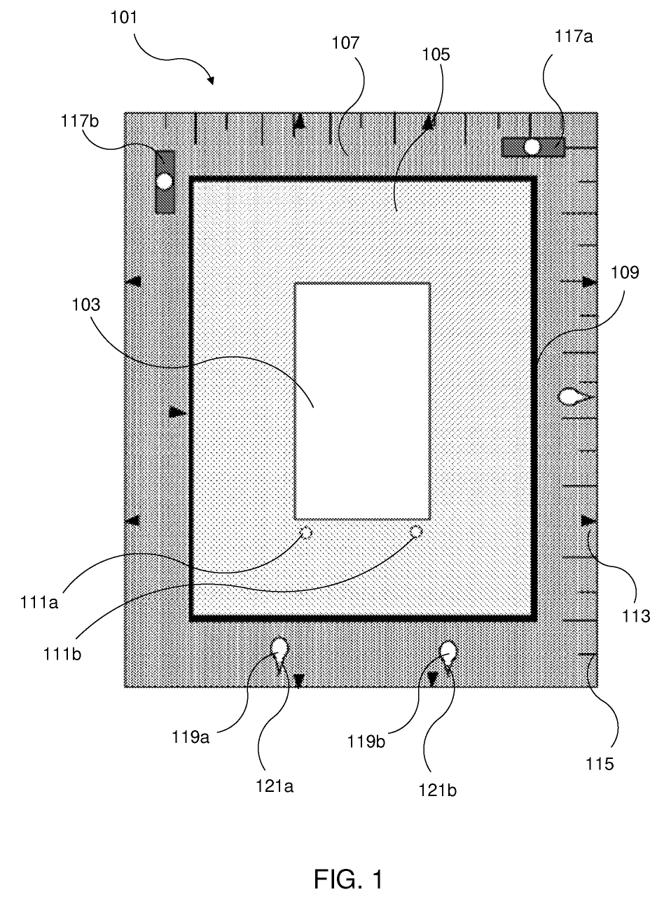

Now referring to FIG. 1, which is a front view of a template for preparing an opening for an electrical utility box in drywall. The template 101 comprises an inner plate 105. The inner plate comprises a first thickness. In some implementations the first thickness of the inner plate is between about 1/32 inch and 1/2 inch. In some implementations the inner plate is about 1/32, 1/16, 3/32, 1/8, 5/32, 3/16, 7/32, 1/4, 9/32, 5/16, 11/32, 3/8, 13/32, 7/16, 15/32, or ½ inch. Within the inner plate 105 is an aperture 103. The aperture 103 may define the outline of the front of the electrical utility box. Surrounding the inner plate is a frame 107. In some implementations such as that depicted in FIG. 1 the frame entirely surrounds the inner plate 105. The frame 107 comprises a second thickness. In most implementations, the second thickness of the frame 107 is greater than the first thickness of inner plate 105. In some implementations the second thickness of the frame is between about 1/32 inch and 3/4 inch. In some implementations the inner plate is about 1/32, 1/16, 3/32, 1/8, 5/32, 3/16, 7/32, 1/4, 9/32, 5/16, 11/32, 3/8, 13/32, 7/16, 15/32, 1/2, 17/32, 9/16, 19/32, 5/8, 21/32, 11/16, 23/32, or 3/4 inch. In implementations where the second thickness of the frame 107 is greater than the first thickness of the inner plate 105, the frame 107 creates a guide 109 for directing a cutting tool. In some implementations the cutting tool uses the aperture as the guide in cutting an opening in drywall. In implementations where the inner plate 105 and the frame 107 comprise the same thickness, the guide 109 for directing a cutting tool is thicker and extends above the surface of the inner plate 105 far enough to interact with the base of the router or drywall cutout tool. The guide 109 will direct the base of the tool and thus direct the cutting of an opening in the drywall.

The frame includes other elements to assist in preparing an opening in drywall. These other elements include measurement marks, alignment aids, attachment holes, and cinch divots. The measurement marks are markings at 1/2 inch increments. The measurement marks, such as measurement mark 115, essentially act as a ruler along at least one edge of the frame. In the depicted implementation, the measurement marks are along the top side and left side. The alignment aids 113a, 113b, 113c, 113d, 113e, 113f, 113g, and 113h align with the edges of the aperture. Alignment aids 113a and 113f align with the bottom edge of the aperture103. Alignment aids 113b and 113e align with the top edge of the aperture 103. Alignment aids 113c and 113h align with the right edge of the aperture 103. Alignment aids 113d and 113g align with the left edge of the aperture 103. The alignment aids assist in placing the template 101 in the correct place so as to cut an opening in drywall in the correct location. Attachment holes 119a and 119b may be used to attach a board to define a height at which the template is positioned above a surface. Cinch divots 121a and 121b are located in base of the attachment holes 119a and 119b. The cinch divots 121a and 121b may be used to secure a line in place, such as a line attached to a plumb bob.

The template also includes elements to ensure that the openings cut in the drywall are strait and aligned with the walls, ceiling, and floor of the space in which they are placed. The template includes leveling devices 117a and 117b to identify when the template is a level position. Leveling devices 117a and 117b are spirit levels placed in the frame 107. In some implementations other leveling devices may be used and include, but are not limited to, laser levels, gyroscopic levels, and digital levels. The leveling device 117b is near a top edge of the template. The leveling device 117b is used when the opening in drywall is in a horizontal position. In some implementations, a second leveling device 117a, is placed in the frame near a side edge. Leveling device 117a is used when the opening is to be prepared in a vertical position.

The template is to be used in preparing the interior of new construction, or renovation. Generally, the template will be a part of the gear a work crew uses in preparing the space. As such the template should be lightweight, to be easily transportable. The template should also be inexpensive as the template may be lost or misplaced. The template may be constructed of a lightweight material such as plastic, metal, or wood. In implementations where the template is constructed of metal, the metal may be stainless steel, aluminum, anodized aluminum, or other metal. In implementations where the template is constructed of plastic, the plastic may be transparent. The transparent template may be beneficial in allowing the worker to see what is going on behind the template. A plastic template may be molded, cast, or printed.

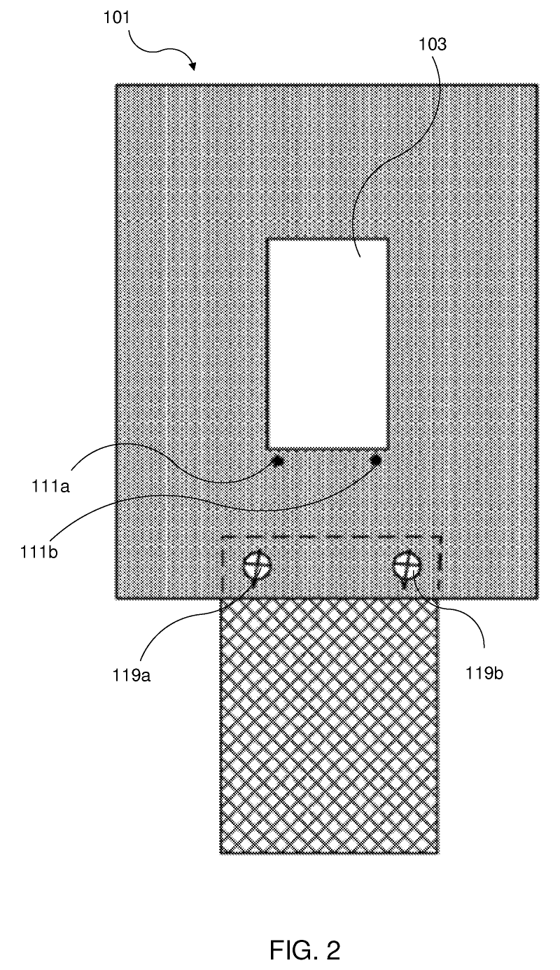

FIG. 2 is a back view of a template for preparing an opening in drywall. The back side or the side of the template which is in contact with the wall is primarily flat. The flat surface of the template enables the template to sit flush against the drywall. Having a template that is flush against the wall, assists in obtaining more precise cuts for the opening cut in the drywall. A template that is not flush against the drywall may rock or rotate as the opening is prepared in the drywall. If the template is rocking or rotating as an opening in the drywall is prepared in the drywall, the opening may not be cut as precisely. An opening that is less precise may not fit an electrical utility box. A less precise opening may be too small, and the electrical utility box will not slide into place through the opening, this could lead to another cut being necessary to enlarge the opening, or it could result in an electrical utility box being forced or attempted to be forced through the opening. Forcing or attempting to force an electrical utility box through an opening that is too small may result in breaking the drywall, this would also lead to time-consuming repairs. A less precise opening may be too large, and the electrical utility box will not remain in place within the opening. Alternatively, the cover for the electrical utility box will not cover the opening.

In implementations the back side of the template also includes elements to secure the template to the drywall. In the depicted embodiment of FIG. 2, the elements used to secure the template to the drywall are piercing barbs 211a and 211b. The piercing barbs 211a and 211b are shaped and sized to push into the drywall. Pushing into the drywall adheres the template to the drywall and keeps the template adhered to the wall and in place. The shape of the piercing barbs may be a cone, a triangular pyramid (tetrahedron), a square pyramid, a pentagonal pyramid, a hexagonal pyramid, or any pyramid with a polygonal base. The piercing barbs 211a and 211b are located near the aperture 103. As the backside of the template 101 is placed against the drywall, pressure may be applied to push the piercing barbs 211a and 211b into the drywall. In some implementations, the piercing barbs 211a and 211b are slowly pushed into the drywall. In some implementations, the template is struck with another tool and the piercing barbs 211a and 211b are struck into the drywall. In some implementations there are two piercing barbs. Two piercing barbs may increase the stability and ability of the template to adhere to the drywall. A single piercing barb would provide a point around which the template could rotate. Rotation of the template may lead to challenges in preparing openings in drywall. In some implementations there are more than two piercing barbs. More piercing barbs may keep the template more firmly adhered to the drywall. In implementations, additional piercing barbs may be placed around other sides of the aperture.

The template also includes attachment holes 119a and 119b. The attachment holes enable adding a spacer to the bottom of the template 101. A spacer may assist in placing openings for electrical utility boxes a consistent height above a surface. For example, the template may be attached to an end of a standard dimension lumber board with nails or screws through the attachment holes 119a and 119b. The standard dimension lumber board provides a base and a consistent height for placing the opening for electrical utility boxes. In another implementation, the template may be attached to a side of a standard dimension lumber board. In such implementations where the template is attached to a side of a board, the height of the board may be cut to any height desired. A higher spacer may be beneficial in situations where the opening for an electrical utility box is higher on a wall. The attachment holes 119a and 119b are positioned to provide stability for the template when attached to a board. In the implementation depicted in FIG. 2, the attachment holes are positioned for use with a 2x4. 2x4 boards are the most commonly used in interior construction. The template may be attached to either the 2 inch or the 4-inch side of the 2x4. This positioning is a versatile option for use with multiple size boards such as 2x6, 2x8, 2x10, 2x12, 4x4, 4x6, 4x8, 4x10, 4x12 or other sizes. In other implementations, the attachment holes may be spaced for other boards.

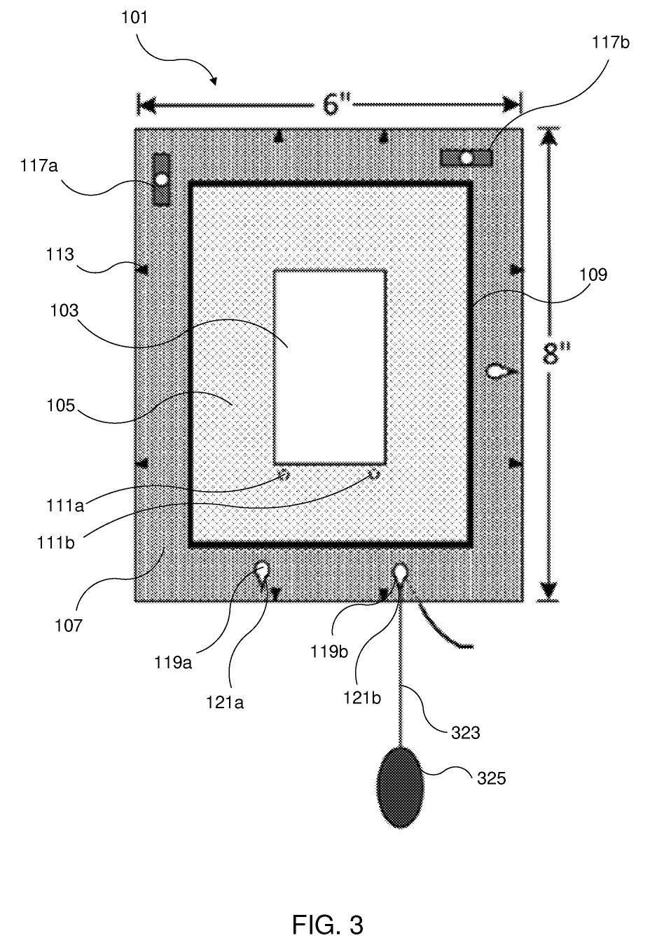

FIG. 3 is a front view of a template for preparing an opening in drywall with a plumb bob attached to a cinch divot. The template 101 comprises an inner plate 105. Within the inner plate 105 is an aperture 103. The aperture 103 defines the outline of the front of the electrical utility box. Surrounding the inner plate is a frame 107. In some implementations such as that depicted in FIG. 1 the frame entirely surrounds the inner plate 105. The frame 107 comprises a second thickness. In implementations where the second thickness of the frame 107 is greater than the first thickness of the inner plate 105, the frame 107 creates a guide 109 for directing a cutting tool. A cutting tool such as a router or drywall cutout tool includes a base. The base of the router or drywall cutout tool interacts with the guide 109, and the guide directs the router in cutting the opening in the drywall. Other cutting tools include drywall saws, oscillating saws/multitools, reciprocating saws, and jigsaws. In some implementations these cutting tools use the aperture as the guide in cutting an opening in drywall. In implementations where the inner plate 105 and the frame 107 comprise the same thickness, the guide 109 for directing a cutting tool is thicker and extends above the surface of the inner plate 105 far enough to interact with the base of the router or drywall cutout tool. The guide 109 will direct the base of the tool and thus direct the cutting of the drywall.

The frame includes other elements to assist in preparing an opening in drywall. These other elements include measurement marks, alignment aids, attachment holes, and cinch divots. The measurement marks are markings at 1/2 inch increments. Measurement marks, such as measurement mark 115, essentially act as a ruler along at least one edge of the frame. In the depicted implementation, the measurement marks are along the top side and left side of the frame of the template. The alignment aids 113a, 113b, 113c, 113d, 113e, 113f, 113g, and 113h align with the edges of the aperture. Alignment aids 113a and 113f align with the bottom edge of the aperture 103. Alignment aids 113b and 113e align with the top edge of the aperture 103. Alignment aids 113c and 113h align with the right edge of the aperture 103. Alignment aids 113d and 113g align with the left edge of the aperture 103. The alignment aids assist in placing the template 101 in the correct place so as to cut an opening in drywall in the correct location. Attachment holes 119a and 119b may be used to attach a board to define a height at which the template is positioned above a surface. The cinch divots 121a and 121b may be positioned at the base of the attachment holes 119a and 119b. The cinch divots 121a and 121b may be used to secure a plumb line 323 in place, such as line attached to a plumb bob 325. A plumb line ensures vertical alignment by utilizing gravity to create a perfectly vertical reference line. It consists of a weight, called a plumb bob, suspended on a string. When the plumb bob is allowed to hang freely, it aligns itself with the Earth's gravitational pull, creating a straight vertical line.

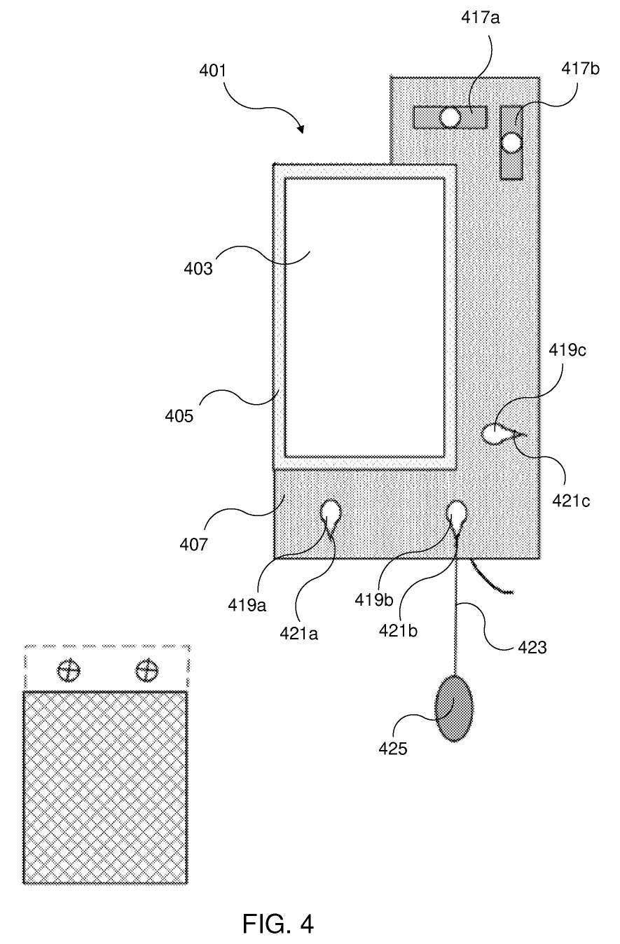

FIG. 4 is a front view of a template for preparing an opening in drywall. The template 401 is a smaller template. The smaller size of template 401 allows it to be more easily carried or stored. The template 401 comprises an aperture 403 in an inner plate 405. A frame 407 at least partially surrounds the inner plate 405. In some implementations, the inner plate 405 and the frame 407 are the same thickness. In some implementations the inner plate 405 is a first thickness and the frame 407 is a second thickness. In some implementations, the second thickness of the frame 407 is greater than the first thickness of the inner plate 405.

The template 401 includes elements that assist in preparing an opening in drywall. The elements of the template include attachment holes, cinch divots, leveling devices, and attachment features. The attachment holes 419a and 419b are near the base of the template when the template is oriented to prepare an opening in a vertical orientation. The attachment holes 419a and 419b enable a board to be used as a height template. Often the board is attached on an end of the board. This is the most common orientation of the board and gives a consistent height above a surface. The cinch divots 421a and 421b hold lines in place and enable quick movement of those lines. A line such as line 423 with plumb bob 425 is threaded through attachment hole 419b, the line is positioned at a desired height, the line 423 is pulled into the cinch divot 421b. The cinch divot 421b securely holds the line 423 in place.

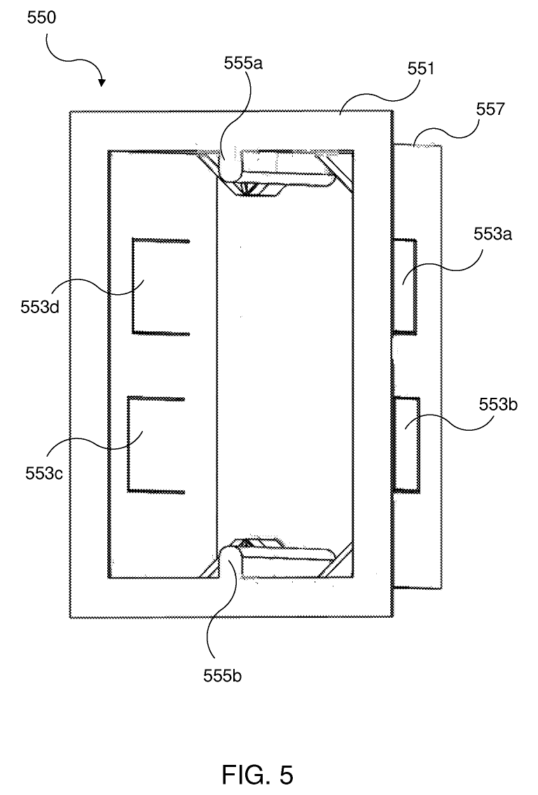

FIG. 5 is a front perspective view of a self-securing single gang electrical utility box. The electrical utility box is designed to fit within the opening of the template previously described. The electrical utility box is designed to be placed in any location. A limitation of traditional electrical utility boxes is that they are secured to studs within the wall. The requirement that traditional electrical utility boxes be secured to studs limits the places where electrical utility boxes may be placed. The electrical utility box includes a frame 551 which is placed against the front, or room side, of drywall. The box 557 holds the electrical outlets or electrical relays. The box 557 is the same size as the opening cut in the wall. The box includes tabs 553a, 553b, 553c, and 553d. The tabs flex or push inward as the box is slid into the opening cut in the drywall. Once the frame 551 contacts the room side of the drywall, the tabs spring back into their non-flexed position. The tabs 553a, 553b, 553c, and 553d contact the wall side of the drywall. The space between the tabs and the frame 551 is the thickness of the drywall. Drywall typically comes in thicknesses of 1/4, 3/8, 1/2, and 5/8 inch. The electrical utility box may come in multiple sizes to accommodate different thicknesses of drywall. The electrical utility box 550 also includes securing pillars 555a and 555b. The securing pillars 555a and 555b accept fasteners such as screws or bolts. This enables an electrical switch or outlet box to be affixed to the electrical utility box.

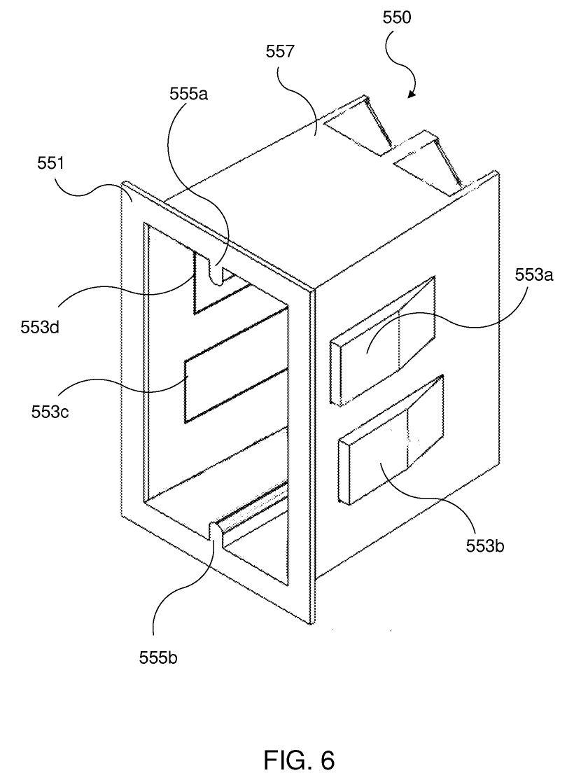

FIG. 6 is a top-down perspective view of a self-securing single gang electrical box. The electrical utility box is designed to fit within the opening of the template previously described. The electrical utility box is designed to be placed in any location. A limitation of traditional electrical utility boxes is that they are secured to studs within the wall. The requirement that traditional electrical utility boxes be secured to studs limits the places where electrical utility boxes may be placed. The electrical utility box includes a frame 551 which is placed against the front, or room side, of drywall. The box 557 holds the electrical outlets, electrical relays, or electrical junctions. The box 557 is the same size as the opening cut in the wall. The box includes tabs 553a, 553b, 553c, and 553d. The tabs flex or push inward as the box is slid into the opening cut in the drywall. Once the frame 551 contacts the room side of the drywall, the tabs spring back into their non-flexed position. The tabs 553a, 553b, 553c, and 553d contact the wall side of the drywall. The space between the tabs and the frame 551 is the thickness of the drywall. The fit is a pressure fit between the frame 551 and the tabs 553a, 553b, 553c, and 553d. Drywall typically comes in thicknesses of 1/4, 3/8, 1/2, and 5/8 inch. The electrical utility box may come in multiple sizes to accommodate different thicknesses of drywall. The electrical utility box 550 also includes securing pillars 555a and 555b. The securing pillars 555a and 555b accept fasteners such as screws or bolts. This enables an electrical switch or outlet to be affixed to the electrical utility box.

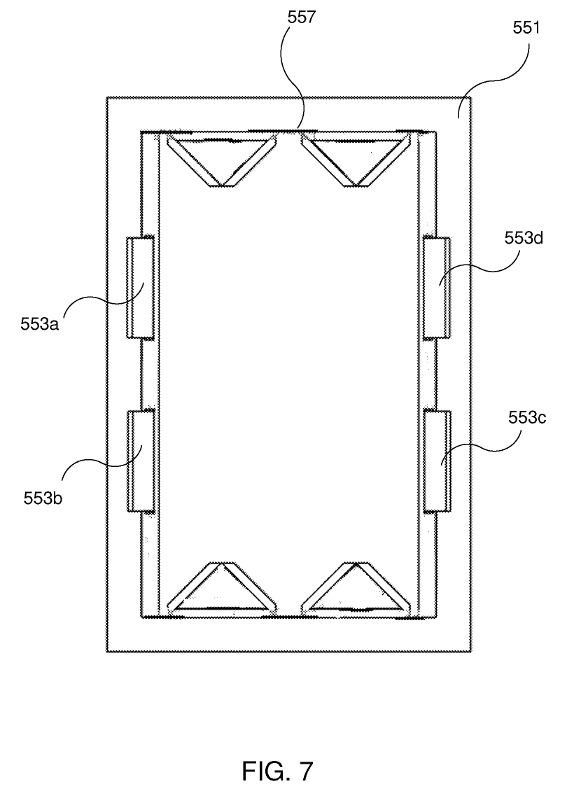

FIG. 7 is a back view of a self-securing single gang electrical box. The electrical utility box is designed to fit within the opening of the template previously described. The electrical utility box is designed to be placed in any location. A limitation of traditional electrical utility boxes is that they are secured to studs within the wall. The requirement that traditional electrical utility boxes be secured to studs limits the places where electrical utility boxes may be placed. The electrical utility box includes a frame 551 which is placed against the front, or room side, of drywall. The box 557 holds the electrical outlets or electrical relays. The box 557 is the same size as the opening cut in the wall. The box includes tabs 553a, 553b, 553c, and 553d. The tabs flex or push inward as the box is slid into the opening cut in the drywall. Once the frame 551 contacts the room side of the drywall, the tabs spring back into their non-flexed position. The tabs 553a, 553b, 553c, and 553d contact the wall side of the drywall. The space between the tabs and the frame 551 is the thickness of the drywall. Drywall typically comes in thicknesses of 1/4, 3/8, 1/2, and 5/8 inch. The electrical utility box may come in multiple sizes to accommodate different thicknesses of drywall.

Together the template and the electrical utility box form a system for installing electrical utility boxes. The template is used to locate and prepare an opening for an electrical utility box. Once the opening is prepared, the electrical utility box is placed within the opening.

The invention has been described with reference to various specific embodiments and techniques. Nevertheless, it is understood that many variations and modifications may be made while remaining within the spirit and scope of the invention.

What is claimed is:

1. A template for preparing an opening in drywall, for electrical utility boxes, the template comprising:
an inner plate with an aperture, the aperture configured to define an outline of the opening to accommodate an electrical utility box;
a frame, surrounding a portion of the inner plate;
a guide for directing a cutting tool between the inner plate and the frame; and
wherein the template is configured to adhere to a wall and to remain adhered to the wall as the guide directs the cutting tool in preparing the openings in the drywall.

2. The template of claim 1, wherein the frame, surrounding a portion of the inner plate, surrounds the entire inner plate.

3. The template of claim 2, wherein the guide is configured to direct a cutting tool in preparing the opening in the drywall.

4. The template of claim 1, wherein the inner plate comprises a first thickness and the frame comprises a second thickness.

5. The template of claim 4, wherein the second thickness of the frame is greater than the first thickness of the inner plate.

6. The template of claim 1, further comprising piercing barbs to adhere the template to the wall.

7. The template of claim 6, wherein the piercing barbs are positioned so that when a cover is installed over the opening in the drywall, indentations created by the barbs are covered by the cover.

8. The template of claim 1, further comprising alignment aids around a periphery of the frame.

9. The template of claim 1, further comprising increment marks.

10. The template, of claim 1, further comprising mounting holes for attaching the template to a board.

11. The template of claim 1, further comprising a cinch divot for attaching a plumb line.

12. A template for cutting openings in drywall comprising:
an inner plate of a first thickness, comprising an aperture configured to accommodate an electrical utility box;
a frame of a second thickness, greater than the first thickness, surrounding a portion of the inner plate; and
wherein the template adheres to a wall and remains in place as the opening is cut in the drywall.

13. The template of claim 12, wherein the frame completely surrounds the inner plate.

14. The template of claim 13, wherein the frame creates a guide for a router to cut the openings in the drywall.

15. The template of claim 12, further comprising piercing barbs to adhere the template to the wall.

16. The template of claim 12, further comprising a cinch divot for attaching a plumb bob.

17. The template of claim 12, wherein the template comprises a transparent material.

18. The template of claim 12, further comprising a level.

19. A system for installing electrical utility boxes comprising:
a template comprising:
an inner plate with an aperture, the aperture configured to define an outline of the opening to accommodate an electrical utility box;
a frame, surrounding a portion of the inner plate;
a guide for directing a cutting tool between the inner plate and the frame; and
a self-securing electrical utility box;
wherein the template is configured to adhere to a wall and to remain adhered to the wall as the guide directs the cutting tool in preparing the openings in the drywall; and
wherein the self-securing box is slid into the prepared opening.

20. The system of claim 19, wherein the self-securing electrical utility box is held in place by tabs which flex to allow the box to slide through the opening.
